(19) United States
(12) Patent Application Publication
(10) Pub. No.: US 2013/0088354 A1
(43) Pub. Date: Apr. 11, 2013

(54) System, Method and Device for Tracking Surgical Sponges

(71) Applicant: Jackson Thomas, Severna Park, MD (US)

(72) Inventor: Jackson Thomas, Severna Park, MD (US)

(21) Appl. No.: 13/269,494

(22) Filed: Oct. 7, 2011

(51) Int. Cl. G08B 13/14

(52) U.S. Cl. 340/572.1

(57) ABSTRACT

A system, method, and device for tracking surgical sponges for a medical procedure is provided. In one embodiment, the system includes a sleeve having a first open end and a second open end and being configured to be removably disposed outside an outer surface of a receptacle. The sleeve including an RF reader having a first antenna assembly comprised of at least one antenna and configured to radiate sponges that enter the receptacle and to receive identifying (ID) information from radiated sponges. The sleeve may include a wireless transmitter electrically connected to said RF reader and configured to receive from said RF reader the ID information of radiated sponges and to wirelessly transmit the ID information of radiated sponges.

### FIELD OF THE INVENTION

The present invention generally relates to systems, devices and methods for tracking medical supplies, devices and equipment, and more particularly for tracking surgical sponges and other supplies, devices and equipment that may be used during a medical procedure.

### BACKGROUND OF THE INVENTION

Medical procedures, such as surgeries, biopsies and other diagnostic and treatment procedures often require a variety of medical supplies, devices and equipment. In addition, multiple doctors, nurses and technicians may be involved. The more complex the procedure and setting, the greater the potential risk is for error. Further, as patient traffic within a setting (e.g., a given operating room) increases, and as personnel work longer shifts and perform more complex procedures, the potential for error increases.

An example of such an error is inadvertently leaving a surgical sponge within the patient's body cavity. Various tissue may be cut during a medical procedure resulting in bleeding. Surgical sponges are typically placed in the patient's body cavity to absorb the blood. After the surgical sponges become saturated with blood, they can be difficult to see in a patient's body cavity. As a result, the medical professionals sometimes overlook a sponge, leaving it in the body cavity when closing the body cavity. Leaving a surgical sponge within the patient may lead to an infection or other undesirable and dangerous reaction. Further, such error leads to increased cost, because another operation is typically required to remove the sponge. The significance of such an error is apparent by the number of times such error has been known to occur. Statistical researchers, for example, estimate that such errors occur thousands of times each year, and refer to the event as a Gossypiboma. Accordingly, there is a need for tracking surgical sponges and other supplies to provide safer, more effective medical procedures.

Further, there is a need to track the use of various devices and equipment, such as to assure that such devices and equipment are properly maintained. These and other needs may be addressed by one or more embodiments of the present invention.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 is a block diagram of a system for tracking surgical sponges, according to an example embodiment of the present invention;

FIG. 2 is a flow chart of a method of tracking sponges according to an example embodiment of the present invention;

FIG. 3 is a flow chart of processing sponge data to track sponges according to an example embodiment of the present invention;

FIG. 4 is a flow chart of a method for tracking surgical sponges, and other medical supplies, devices and equipment, according to an example embodiment of the present invention; and

FIGS. 5a-b depict a bucket assembly according to an example embodiment of the present invention.

### DETAILED DESCRIPTION OF ILLUSTRATIVE EMBODIMENTS

In the following description, for purposes of explanation and not limitation, specific details are set forth, such as particular networks, devices, computers, radio frequency (RF) tags, components, techniques, data and network protocols, software products and systems, radio frequency (RF) readers, enterprise applications, operating systems, development interfaces, hardware, etc. in order to provide a thorough understanding of the present invention.

However, it will be apparent to one skilled in the art that the present invention may be practiced in other embodiments that depart from these specific details. Detailed descriptions of well-known networks, devices, computers, terminals, components, techniques, data and network protocols, radio frequency (RF) tags, radio frequency (RF) readers software products and systems, operating systems, development interfaces, and hardware are omitted so as not to obscure the description of the present invention.

According to an embodiment of the present invention, a system and method for tracking surgical sponges in real time is provided. Each sponge includes a small radio frequency identification (RFID) tag/inlay (having a unique identifying number). For example, the RFID tag may be embedded in the sponge and/or otherwise attached to the sponge, such as the concept of a hand tag located along a string attached to the sponge. Sponges may be scanned prior to use and after use to track and count the sponges. For example, when preparing an operating room for a medical procedure (and prior to the procedure) each sponge may be scanned. Each sponge may have a unique identifying number, allowing specific sponges to be tracked and for counting the number of sponges and the number of each type of sponge.

After a sponge is used, it is discarded. Because the sponges soak up blood and other bodily fluids, the used sponges are biohazardous waste. In some embodiments, a hazardous waste bin may have an attached loop antenna through which sponges pass when being discarded into the waste bin.

An RF reader may be electrically connected to the antenna to read the RFID tag ID of each sponge discarded. In turn, the RFID reader provides the ID data to a wireless transceiver that wirelessly transmits the RFID tag ID (in encrypted form) to a computer (e.g., a local handheld Bluetooth device, laptop, or network terminal). In an example embodiment, software resident on the computer executes program code to identify the number of sponges provided for a procedure, the number of sponges remaining unused after the procedure, and the number of sponges discarded during (and after) the procedure. The computer then determines if all sponges are accounted for or if a discrepancy exists. Further, an alarm or other notification may be generated when there is a discrepancy. Of course, variations of the method may be implemented, such as a method in which only sponges that are opened for imminent use and sponges that are discarded are scanned and the counts (or ID data) compared.

The system and method also may be implemented to track other medical supplies, devices and equipment used during a medical procedure.

Embodiments of the present invention provides a system, method, and device for tracking surgical sponges for a medical procedure. In one embodiment, the system includes an RF reader having an antenna, said antenna configured to be internally attached to a receptacle and to radiate discarded sponges ID's comprising sponges entering the receptacle. The RF reader may be configured to receive unique identifying (ID) information from radiated sponges and provide the ID information to a wireless transmitter electrically connected to the RF reader. The system may include a handheld or tablet computer having a wireless port and configured to wirelessly receive the ID information of discarded surgical sponges from the wireless transmitter. The handheld computer may store in its memory ID information of a plurality of available surgical sponges comprising sponges available for use during the procedure and receive and store ID information of a plurality of unused surgical sponges comprising sponges that were not used during the procedure. In addition, the handheld computer may be configured to process data of the discarded surgical sponges, unused surgical sponges, and available surgical sponges to determine if any available surgical sponge is not discarded and is not unused.

### Tracking System:

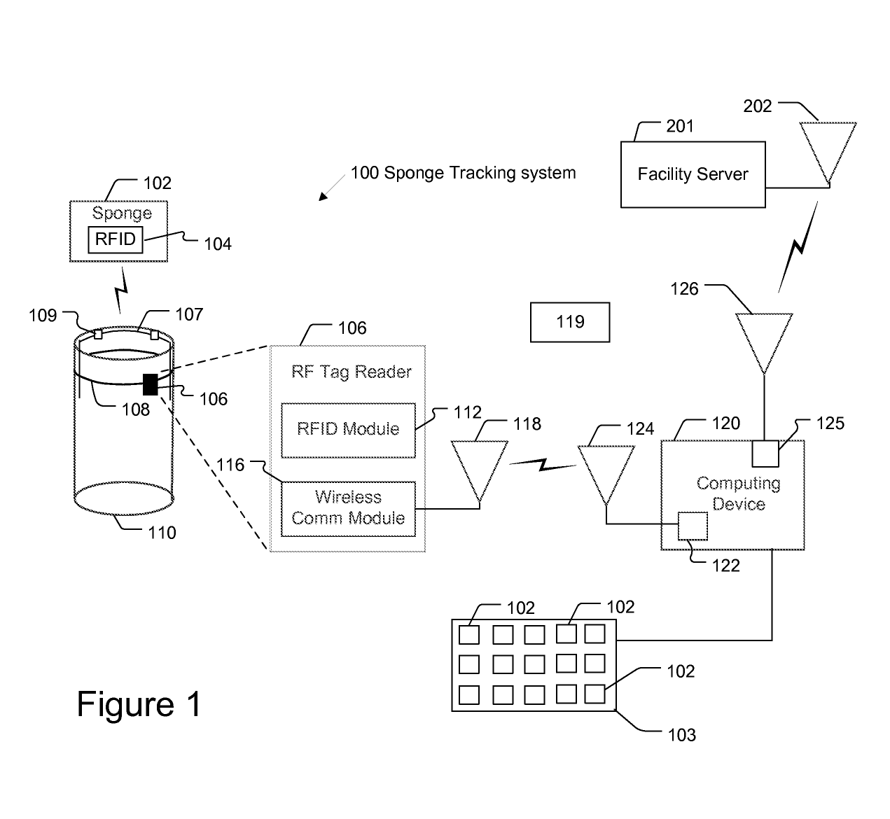

FIG. 1 depicts a system 100 for tracking surgical sponges 102, according to an example embodiment of the present invention. The tracking system 100 includes medically passive RFID tags 104 embedded and/or otherwise attached to one or more surgical sponges 102. An RFID tag 104 serves as a transponder which responds to radio frequency irradiation.

As discussed, each RFID tag has an associated unique ID (e.g., a number). Some RF ID tags can be read from several meters away and beyond the line of sight of the reader. Other tags are less robust. Most RFID tags contain at least two parts. A first part is an integrated circuit for storing and processing information, for modulating and demodulating a radio-frequency (RF) signal, and for other specialized functions. The second part is an antenna for receiving and transmitting the RF signal. It is anticipated that RFID technology will soon omit the chip component and instead allow the RFID tags to be printed directly onto the surgical sponge or other asset being tracked. In this example embodiment, a passive RFID tag 104 responds to a radio frequency signal of sufficient power for the tag's antenna to detect the signal and power the integrated circuit to encode the ID information. In effect the RFID tag 104 is a transponder powered by the incoming signal to transmit the RFID tag ID information in response to a specific incoming radio frequency signal. In another embodiment, the RF ID tags are active tags (e.g., include a power source such as a battery).

An example of an RFID tag 104 suitable for use with a surgical sponge for some embodiments of the present invention may be a Gen 2, 96-bit, passive RFID tag. A read only read or a read/write tag may be employed. The RFID tag 104 may be fixed, tethered or otherwise attached to the asset to be tracked. For example, an RFID tag 104 may be woven into a surgical sponge 102. In some embodiments, the sponge may be tethered to the sponge and encased in a plastic housing that includes a recessed ridge for receiving forceps for extraction or a recessed thumbprint for receiving a person's thumb to facilitate manual extraction. In some embodiments the sponge 102 may include a hole near an edge for a tethered cord to be connected (in which such an RFID tag 104 may be located).

The system 100 also includes an RFID tag reader 106 including an RF module 112 electrically connected to an antenna 108. The RFID module 112 of the RFID tag reader 106 transmits a radio frequency signal via the antenna 108. In various embodiments, the radio frequency signal may be generated automatically and transmitted periodically or aperiodically (or continuously). The radio frequency signals radiate radio RFID tags 104 located within the radiating field of the antenna 108 to allow the RFID tags 104 to provide a response. In a specific embodiment the radio frequency signal may be an Ultra High Frequency (UHF) signal within the range of 902 through 928 MHz or high frequency (HF) 433 Mhz.

The antenna 108 may be a loop antenna or loop/dipole antenna oriented to have peak intensity in a specific plane. In various embodiments the antenna 108 may be read in near field or far field modes. For example, the antenna 108 may be located around the circumference of an opening of the waste bin 110 which receives used discarded sponges. The loop antenna 108 may be positioned, for example, by attaching an apron 107 with hooks 109 over the opening of the discard bin 110. The apron may be angled so when a sponge is discarded, the sponge 104 passes through the loop opening and drops into the bin 110. The apron 107 may be made of disposable material so that it could be discarded after each procedure. In this example, the antenna's peak intensity may occur in the plane of the loop so that a sponge's RFID tag 104 is radiated when passing through the waste bin's opening. In some embodiments, the antenna 108 may be suspended below the opening, with energy propagating upward to radiate the entire opening of the waste bin 110.

In another embodiment, the antenna 108 may be located along a wall of the discard bin 110 and have a peak intensity perpendicular to the plane of the loop. The antenna may radiate an entire portion of the waste bin 110, such as the area near the bin's opening.

Although not specifically depicted, the RF tag reader 106 also includes a power supply and filtering circuitry for receiving power from a conventional wall socket. In another embodiment, the RF tag reader 106 may be battery powered. The RF module 112 may include a transceiver for transmitting and receiving RF signals. For example, the RF module 112 may generate a RF beacon signal or other RF signal output to be radiated by the antenna 108. As discussed, the output signal is a radio frequency signal transmitted at sufficient power to excite the RFID tags 104 that may pass or otherwise be located within a desired radiating field of the antenna 108.

The RF module 112 also may receive RFID signals containing ID information from the RFID tags 104 from the antenna 108. In particular, the RFID module's RF output signal causes the near field antenna 108 to radiate an output field. An RFID tag passing through such field may be powered by such radiation to generate an RFID signal with ID information of the associated sponge. The RFID signal may repeat while the RFID tag 104 remains exposed to the radiation from antenna 108. The ID information of the RFID signal may be used to determine the sponge which was discarded into the waste bin 110.

The received ID information may then be provided to the wireless communication module 116 by the RF module 112. In some embodiments, the RF module 112 may decode and/or reformat the ID data carried in the RFID signal. The wireless communication module 116 receives the ID information from the RFID module 112 and packages (e.g., formats) the data for wireless transmission. An antenna 118 may be electrically connected to the wireless communication module 116. Various wireless protocols may be implemented, such as Bluetooth, wireless USB, ultra wideband, and the various wireless local area network (WLAN) protocols defined by the IEEE 802.11 family of specifications, (e.g., 802.11, 802.11a, 802.11b, 802.11g, and 802.11n).

The system 100 for tracking surgical sponges 102 also may include a computing device 120, such as a personal computer, laptop, handheld device, tablet, cart on wheels, or network terminal. The ID information from the radiated RFID tags 104 may be transmitted via a wireless Bluetooth communication to the computing device 120 where the data is stored and processed. Thus, the computing device 120 may include a processor, memory, and a wireless communication module 122 having a short range transceiver and antenna 124 for communicating with the RF tag reader. In addition, the computing device 120 may include a second (wireless) transceiver 125 and antenna 126 for communications (e.g., Bluetooth, IEEE 802.11 a/b/g/n (Wifi)) with a remote computer system 201 such as a server configured manage inventory, billing, maintenance and other processes. A single computing device 120 may operate (and communicate) with multiple RF Tag readers 106/406 concurrently or separately and therefore track the sponges discarded into multiple waste bins and/or bucket assemblies 400 during a single medical procedure. Likewise, a single computing device may communicate with multiple trays 103 concurrently. The ability to communicate with multiple trays 103 and to track sponges discarded into multiple waste bins 110 and/or buckets 400 may be advantageous in some scenarios, such as transplants when two patients are undergoing the same procedure, in which the use of trays 103, waste bins 110, and/or buckets 400 are desirable.

In some embodiments, the computing device 120 may store software for executable to control the process of tracking surgical sponges. Reports, alarms, and other outputs may be generated as part of the tracking process. The data, and the process outputs also may be sent to another computing system for archiving the data and the results. The computing device 120 or other computing system also may pass data to an electronic patient record system.

In addition, this embodiment may include a tray 103 for holding sponges 102 to be used during the procedure. The tray 103 may include an RF reader and antenna (e.g., embedded in the tray 103 or around the perimeter of the tray 103) that are configured to radiate sponges resting on the tray 103. The tray be communicatively coupled to the computing device 122 (via a wireless link or wired link such through a docking mechanism) and transmit data of each sponge that is placed on the tray (the ID information of each sponge) and transmit data of each sponge that is removed from the tray 103 (the ID information of each sponge). The computing device 122 may store the time that each sponge is placed on the tray 103 and the time that each sponge is removed from the tray. Thus, the tray 103 may provide the computing device 122 the ID information of each sponge 102 that is available for use during the operating procedure for storage. If at the end of a procedure a sponge 102 is missing (not discarded and not on the tray), the computing device 1222 may output the time that the missing sponge was removed from the tray 103 (and type of sponge 102 that is missing), which may allow operating room personnel to more quickly locate the missing sponge 102.

In addition, the system may include a bar code reader 119 that communicates with the computing device 122 wirelessly or via a wired connection (such as through a docking mechanism). A bar code on the packaging of each sponge may be read using the bar code reader 119 and the information supplied to the computing device 122 from the bar code reader 119. The bar code information may be the same as the RF ID of the sponge or may be different. The bar code of each sponge is read by the bar code reader 119 as each sponge is placed on the tray 103. Based on the number of bar codes from the bar code reader 119, the computing device 122 maintains a tally of the number of sponges placed on the tray 103, which should equate to the number RF IDs read by the RF reader of the tray 103. If, however, one of the sponges 102 on the tray 103 includes an RF ID tag that has failed it will not be able to be read by the RF reader of the tray 103, which would means that if it were left in the patient the system might not detect the error. Thus, the computing device compares the number of the number of sponges as read by the bar code reader 119 with the number of IDs of sponges read by the RF reader of the tray 103. If the numbers are the same, there are no failed RFID tags in sponges. If the numbers are different, there is a failed RFID tag in one or more sponges. In one embodiment, the system may correlate the sponge whose bar code has a failed RF tag and output the bar code information (or other information) so that personnel can identify and discard the sponge with the failed RFID tag. For example, if the bar code information is the same as the RFID information, the computing device may compare all of the bar codes with the RFIDs of the sponges to determine which bar code does not have a corresponding RFID stored in memory (And output the bar code to the operating room personnel).

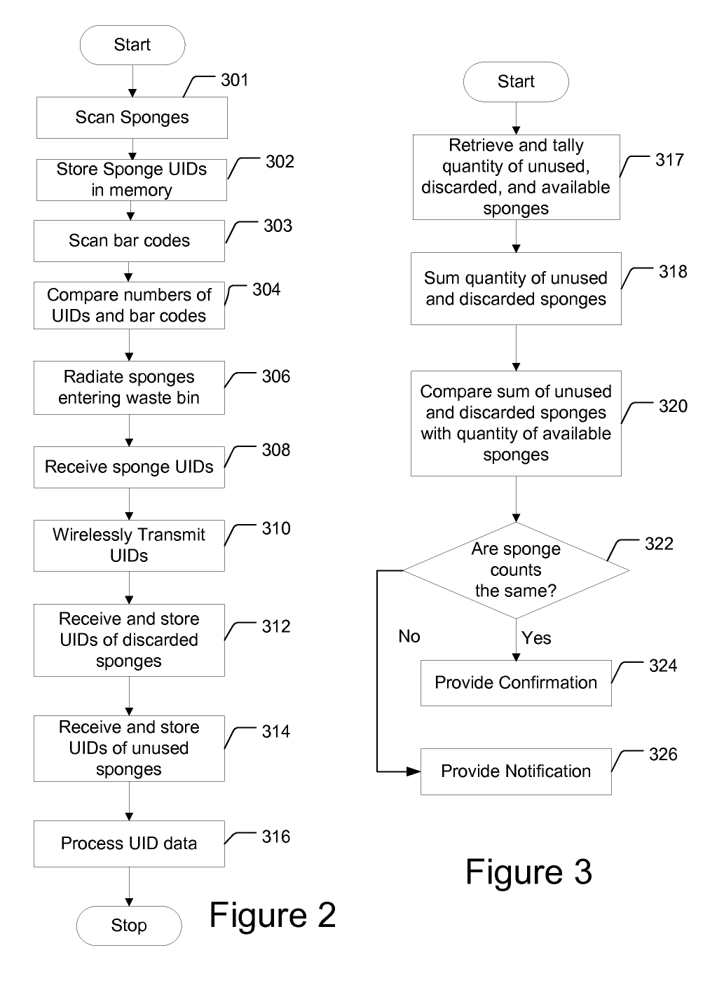

FIG. 2 depicts a process for tracking surgical sponges in accordance with an example embodiment of the present invention. At step 301, all of the sponges provided to the operating room are scanned prior to the beginning of the medical procedure. These sponges are referred to herein as the available sponges (because they are available for use during the procedure). The unique IDs (UIDs) of the available sponges (and total quantity of available sponges) are stored in memory of the computing system 120. The sponges may be scanned by any suitable RFID scanning device such as by the RF reader forming part of (or attached to) tray 103, a handheld scanner or a scanning device that is electrically (or wirelessly) connected to the computing device 120. Alternately, the sponges may be placed through the hoop antenna 180 of the RFID tag reader 106 (prior to the antenna being fasted to the waste bin 110) in which case the computing device 120 receives the UIDs via a wireless transmission from the RF tag reader 106. At step 302, the UIDs of the sponges available for use during the procedure are stored in memory of the computing device 120. As discussed above, at 303 a bar code reader may be used to scan a bar code on the packaging of each sponge 102. At 304, the total number of bar codes (which corresponds to the number of sponges) provided by the bar code reader 119 may be compared to the number of sponges scanned by the RF reader to ensure the two counts are the same (to ensure that the RF tag each sponge has not failed) and if not, an error message may be output along with information identifying the bar code of the sponge whose RF tag is not working properly. Medical personnel may scan additional sponges to add (e.g., to the total count of available sponges) if, during the medical procedure, additional sponges are needed.

At step 306, the sponges entering the waste bin 110 are radiated by the RF tag reader 106. In instances, the reader may concurrently radiate multiple sponges entering the receptacle concurrently and receive the UIDs. At step 308, in response to the radiating, the RF tag reader receives the UIDs of the sponges entering the waste bin 110. At step 310, the received UIDs are wirelessly transmitted (e.g., via a Bluetooth transmission) to the computing device 120 for storage and processing. At step 312, the computing device 120 receives and stores the UIDs of the discarded sponges. As will be evident to those skilled in the art, steps 306-312 (or alternately only steps 306 and 308) may occur each time a sponge enters the waste bin 110.

When the procedure is complete (and before the patient's body cavity is closed), the unused sponges may be scanned. At step 312, the computing device 120 receives and stores the UIDs of the unused sponges. For example, when the medical procedure is near completion and all of the sponges are believed to be removed from the patient and discarded, a medical professional may provide a user input to indicate the scanning of unused sponges. Such scanning may be performed via any suitable method as described above.

When all of the unused sponges have been scanned, the computing device 120 may then process the UID data to identify any discrepancy in the number of available sponges with the number of sponges unused and discarded. The processing may be done in response to a user input to process the UID data (e.g., upon completion of the procedure and before the patient is “closed” a button on the computing device may be actuated). The processing may result in a report that indicates whether any (and how many) unused sponges were not discarded or that all used sponges were discarded.

FIG. 3 depicts an example method for processing of the UID data (step 316) to identify any discrepancy in the number of available sponges with the number of sponges unused and discarded. At step 317, the UIDs of the unused, discarded and available sponges (i.e., sponges available for use during the medical procedure) are retrieved from memory (based on the UID data) and tallied to provide a quantity for each. At step 318, the number of unused sponges (derived from step 314) is added to the number of discarded sponges (derived from step 312) to provide a post procedure sponge count.

At step 320, the post procedure sponge count is compared to the number of available sponges (i.e., the number of sponges available prior to the procedure) derived from step 302. At step 322, the process determines whether the sponge counts (i.e., the available sponges and the post procedure sponge count) are the same. If the sponge counts are the same, the process branches to step 324 and provides a notification confirming that all sponges are accounted for (and none remains in the patient). Upon receiving this confirmation notification, the medical professionals will be confident knowing that no sponges remain in the patient's body cavity and may close the patient's body cavity.

If the sponge counts are not the same (i.e., a discrepancy exists), the process branches to step 326 and provides an alert notification that not all sponges are accounted for. This notification may indicate the number of sponges that were made of available for use (available sponges) and that were neither discarded nor remain unused. Upon receiving this notification, the medical professionals may then seek to locate the one or more sponges that are missing. For example, the medical professional may scan the patient to see if the one or more patients remain in the patient's body cavity. Upon finding the missing sponges, they may be scanned (either via being discarded or via scanning) and the processing of the UID data re-initialized to ensure that no discrepancy exists between the sponges that were (1) made of available for use (available sponges) and (2) those that were discarded or remain unused.

In another embodiment, the method of determining a discrepancy in the number of available sponges with the number of sponges unused and discarded comprises comparing the UIDs of the discarded surgical sponges and the unused surgical sponges with the UIDs of the available surgical sponges to determine if any available surgical sponge is not discarded and is not unused. In other words, instead of tallying the quantity of discarded, unused, and available sponges, the computing system compares the UID (e.g., the ID numbers) of each unused and discarded sponge with the UIDs of the available sponges. For example, the computing device 120 may create a database table that includes the UIDs of the available sponges forming part of each record. As each sponge is later scanned (as a discarded or unused sponge) a flag is inserted into a field of the corresponding UID record. Upon completion of the procedure and scanning of unused sponges, any record in the table that does not include the flag identifies a missing sponge that may remain in the patient. The number of records without a flag may be tallied to provide the quantity of missing sponges.

The present invention also be implemented to track a variety of types of assets (medical supplies, devices and equipment) used or made available for use for medical procedures such as peel packs (surgical instruments), items from materials management (e.g., sponges, sutures, syringes, etc.), electronic equipment (e.g., EKG's, IV pumps, and respirators) from equipment/fixed asset management, consumables such (e.g., drugs, infusion therapy, blood, and saline) from pharmacies and blood banks, and various other types of assets. Data of these assets may be stored in a remote computer system 201 located anywhere in the facility or elsewhere. For instance, all medical equipment can be logged into a fixed asset system (e.g., equipment) where a complete historical profile and maintenance history is created and maintained. If an IV pump is used in an operation the attending nurse can (in real time) pull up the disposition and maintenance history of that particular piece of equipment. Potential problems may be uncovered before they happen in a critical stage of the operation. If the IV pump is past due on it's a maintenance check, the nurse can get a new IV pump.

The assets may be scanned by one or more RF tag readers 106 in the procedure room. In some embodiments, the procedure record (that includes data of the assets used during a procedure) may be processed to provide a billing entry in the facility's billing system, a chart note in a patient's electronic medical record, a scheduling entry in a scheduling system noting the end of the procedure, a maintenance entry indicating maintenance of a piece of equipment is due, an inventory entry decrementing the inventory of one or more items, and/or another entry in any of various information management systems for the patient, surgical team, or facility. In embodiments, bar codes may be scanned to track assets having bar codes attached thereto (in addition to or alternate to using RFID tracking technology).

To track a variety of assets various data may be entered prior to the medical procedure. For example, the room number for the procedure may be entered into the computing device 120. In addition, an employee ID or other data corresponding to a given person or team of people may be entered. A patient ID or other data (e.g., name) indicating a particular person who is to undergo the procedure is entered. A procedure code, such as a CPT code (i.e., current procedural terminology code) also may be entered. In some embodiments a current time or date may be entered or stored. In various embodiments some or all of these steps may be performed in any order. In some embodiments, such data is entered at the computing device 120 or other computer (e.g., that is connected to the remote computer system). For example, such data may already be in a hospital's information management system and be automatically associated with a patient, doctor, technician or room based upon prior scheduling data entries. In such example, these steps need not be performed at the computing device 120, but at other computing systems 201 that may or may not make such data available to the computing device 120.

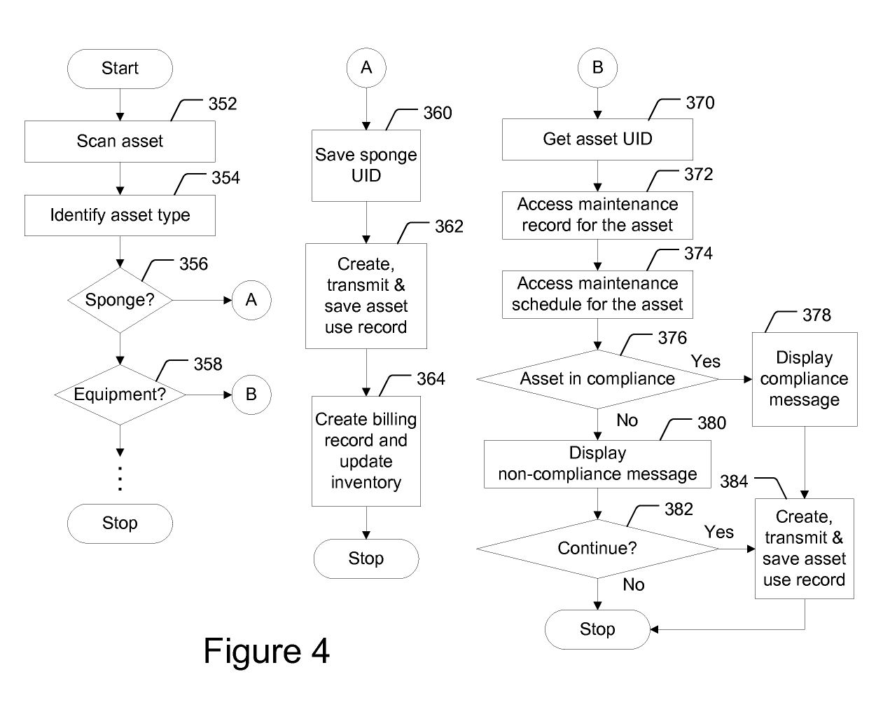

FIG. 4 depicts a method 350 for processing data provided by the scanning of an asset with an RF tag reader (such as RF tag reader 106 or other scanning device such as a bar code reader). As discussed, such scanning may be performed on various assets at various times before, during and after a procedure. At step 352, a given asset is scanned. The asset may comprise any asset that the facility wishes to track such as a material (e.g., a sponge), a consumable (e.g., a medication), equipment (e.g., an EKG machine or IV pump), etc. Thus, in this example embodiment there are a plurality of types of assets that can be scanned. At step 354 the UID from the asset is read and the type of asset is determined such as by the computing device 120 or the remote computer 201. For example, the asset type may be encoded on the RFID tag 104, or may be retrieved from a database that correlates various UID to asset types. The type of asset scanned may determine (in some instances) the process to be next performed. For example, at step 356 the asset type may be determined to be a surgical sponge. If so, then steps 360-362 may be performed. At step 358 the asset type may be determined to be a piece of equipment and steps 370-384 may be performed. Various asset types may be detected to determine a set of processes to be performed for such asset or asset type.

If the asset type is a surgical sponge 102, at step 360 the sponge's UID is stored. At step 362 an asset use record may be stored, transmitted and saved. For example, in embodiments where the computing device 120 includes procedure data, an asset use record may be created, transmitted and stored. In a specific example, the UID of the sponge, along with a patient id, room number, employee id and procedure code may be stored as an asset use record. In some embodiments a time and date stamp also may be included in the asset use. Such record may be sent by the computing device 120 to a remote computer system 201 (e.g., wirelessly via Bluetooth or Wifi or via wired communication). Such remote computer system 201 (discussed above) may comprise a central computer system of the medical facility (or one or more facilities) and be located in the same structure (e.g., in a “computer room”) or remote therefrom (at a data center in which case the communication may traverse the internet).

The remote computer system 201 may save the data and process the data to create a billing record and update an inventory management system at step 364. For example, the remote computer system may create billing records to bill the patient for each surgical sponge discarded (and not bill the patient for sponges not used) as well as other consumable used during a procedure. In some embodiments, the type of sponge may also be determined from the UID information. This may be used to more accurately bill the patient (e.g., different types of sponges may have different costs) as well as to track the remaining inventory of each type of surgical sponge.

As discussed, steps 370-384 may be performed in response to a scan of an equipment asset type such as an EKG or IV pump. At step 370, the asset's UID is received from the scanning. The computing device 120 (or the remote computer system 201) may then determine whether that particular piece of equipment has been maintained according to a prescribed schedule. Specifically, at step 372 the maintenance record for that particular piece of equipment may be retrieved and at step 374 the maintenance schedule for that type of asset (or asset sub-class) is retrieved. At step 376, the process determines whether the retrieved asset maintenance activity is up to date or otherwise in compliance with the retrieved maintenance schedule. Various other processes also may be performed depending on the needs of the facility and type of asset.

If the asset is in compliance with prescribed test criteria, (e.g., the EKG has been maintained according to a maintenance schedule), then a message may be displayed at step 378 at the RF reader 106 indicating such compliance (or no message provided). A record of the asset's use may be generated and saved at step 384. Similarly, if the asset is not in compliance, then a notification may be displayed at step 380 on the computing device 120 that the asset is not in compliance with the maintenance schedule. In a specific example, the UID, along with the patient ID, room number, employee ID and procedure code may be stored as the asset use record. In some embodiments a time and date stamp also may be included in the asset use record. Such record may be sent by the computing device 120 to the remote computer system 201, as previously described. Such remote computer system 201 may save the record and/or process the record to perform billing, patient medical record generation or other accounting, schedule maintenance, or maintaining operation.

For the case where the asset is not in compliance with test criteria, the operator may be asked whether or not to continue use of such asset. For example, the operator may choose to ignore the alert message and proceed by using the piece of equipment for the medical procedure. In such case, an asset use record may be generated at step 384. Alternatively, the operator may choose not to use the piece of equipment. In such case the asset use record need not be generated. Alternatively, in some embodiments an alternative asset use record may be generated such as to record that the piece of equipment was found not to comply with test criteria. Typically, the operator would find and scan a substitute piece of equipment which complies with the test criteria. In some embodiments, some (e.g., equipment, peel packs, ancillaries, etc.) or all of the assets may be tracked using alternate technology such as, for example, bar codes to implement the embodiments described herein.

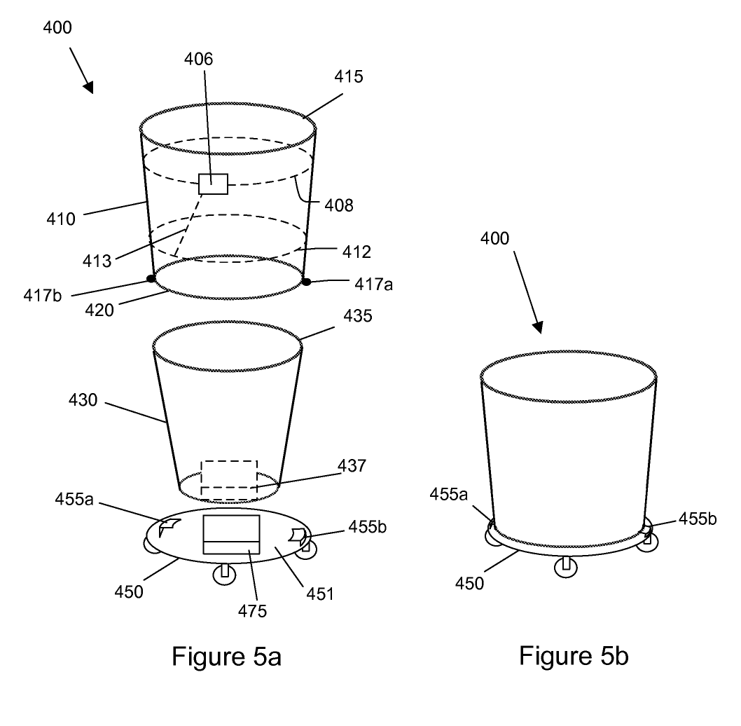

FIGS. 5a-b illustrates a portion of another embodiment of the present invention that employs a bucket assembly 400 that includes a sleeve 410 having a top end 415 and a bottom end 420 (with both ends being open). The sleeve 410 is configured to fit over a bucket 430. The bottom end 420 of the sleeve 410 may be attachable to a castor assembly 450 that comprises three or more castors attached to a substantially horizontal mounting surface 451. The top end 415 of the sleeve 410 is adjacent to, and extends over, the top end 435 of the bucket 430 so that the bucket 430 can move only slightly (e.g., can only move one mm in any lateral direction). Thus, the top end 415 of the sleeve 410 may include a ridge that extends slightly radially inward over the edge of the top end 435 of the bucket 430. In some embodiments, the ridge (not shown) may be located at the top end 415 of the sleeve 410 or may be slightly below (e.g., an inch below) the top end 415 of the sleeve 410. In another embodiment, the top end 415 of the sleeve 410 is mechanically attached to the top end 435 of the bucket 430 to prevent movement of the bucket 430.

The sleeve 410 includes an RF tag reader 406 that includes substantially same components of the RF tag reader 106 discussed above with respect to FIG. 1. Specifically, the RF tag reader 406 includes an RFID module for radiating sponges entering into the bucket 430 and a wireless communication module for communicating data to the computing device 120. The RF module of the RF tag reader 406 is connected to a first antenna assembly 408 and a second antenna assembly 412, which are shown schematically in FIG. 5a. The first antenna assembly 408 may comprise three dipole antennas that integrated into (e.g., during manufacturing) the sleeve 410 at, or near, the top end 415 of the sleeve 410 (e.g., approximately, one tenth, one fifth, one fourth, or one third of the distance from the top end 415 of the sleeve 410). Each of the three integrated antennas may be slightly bent to conform to the circular shape of the sleeve 410 and be disposed around approximately one third (i.e., one hundred twenty degrees) of the circumference of the sleeve 410. The second antenna assembly 412 may comprise two dipole antennas integrated into (e.g., during manufacturing) the sleeve 410 approximately one third of the distance from the bottom end 420 of the sleeve 410. Each of the two integrated antennas of antenna assembly 412 may be slightly bent to conform to the circular shape of the sleeve 410 and be disposed around approximately one half (i.e., one hundred eighty degrees) of the circumference of the sleeve 410. The second antenna assembly 412 is connected to the RF tag reader 406 via an antenna lead 413, which may be integrated into the sleeve 410. In other embodiments, either or both of the antenna assemblies may have fewer or additional antennas and may employ other types of antennas.

The bottom end 420 of the sleeve 410 may include two or more protrusions 417a,b that extends radially outward from the outer surface of the sleeve 410 and that are configured to engage fastening mechanisms 455a,b of castor assembly 450. Specifically, each protrusion extends under a lip (or overhang) of the fastening mechanism 455. When the sleeve 410 placed onto the mounting surface 451 of the castor assembly 450 and rotated, each protrusion is moved into the fastening mechanism 455 (which becomes more narrow), thereby creating a friction fit between the protrusions 417 and fastening mechanisms 455 to hold the sleeve 410 (and therefore the bucket 430) to the castor assembly 450. In other embodiments other means of attaching the sleeve 410 to the castor assembly 450 may be used.

The bottom of the bucket 430 may include a recessed compartment 437 that extends upward into the bucket 430 and that may be sized and shaped to receive a scale 475. Thus, when the bucket assembly 400 is assembled in a first configuration (see FIG. 5b), the bucket 430 rests on the scale 475 which rests on the castor assembly 450. In a second configuration in which the user does not need a scale, the bucket 430 rests directly on the castor assembly 450 and the scale is omitted.

The outside of the sleeve 410 may be shielded, such as by conductive paint to prevent external radio frequency signals from interfering with radiation of discarded sponges 102. The bucket 430 remains unshielded and is manufactured from non-conductive material so that the antennas of the sleeve 410 can radiate sponges, and receive responses from the sponges, through the sides of the bucket 430.

The scale 475 may include a wireless transceiver (e.g., Bluetooth or Wifi transceiver) and be configured to communicate weight information to the computing device 120, which also may store the dry weight of each type of sponge to be used in the procedure. Knowing the dry weight of each type of sponge, the quantity and type of each sponge discarded, the weight of the bucket 430 (received and stored prior to any sponges being discarded), the total weight of fluids discarded into the bucket 430 may be computed by subtracting the dry weight of all of the discarded sponges and the weight of the bucket 430 from the weight as measured by the scale 475. The computing device 120 may convert the computed fluid weight to a fluid volume which may be output on a display to operating personnel. If the computed fluid volume reaches a predetermined threshold (which may vary and be computed by the computing device 120 based on the weight of the patient) a notification (e.g., an alarm) may be output to medical personnel to ensure that substantial fluid loss is recognized so that appropriate action may be taken.

Software the executes in the computing device 120, the RF reader 106/406, and/or the tray 103 may be upgraded by receiving a wireless software update, which may be stored in memory for execution by the respective device. In addition, the sleeve 410 and/or waste bin 110 may include an external power port that allows the device to be plugged into a conventional wall socket during the medical procedure and/or to recharge batteries that supply power to the RF reader 406 and 106.

In one embodiment, the system includes an RF reader having an antenna, said antenna configured to be removably attached to a receptacle and to radiate discarded sponges comprising sponges entering the receptacle. The RF reader may be configured to receive unique identifying (ID) information from radiated sponges and provide the ID information to a wireless transmitter electrically connected to the RF reader. The system may include a handheld computer having a wireless port and configured to wirelessly receive the ID information of discarded surgical sponges from the wireless transmitter. The handheld computer may store in its memory ID information of a plurality of available surgical sponges comprising sponges available for use during the procedure and receive and store ID information of a plurality of unused surgical sponges comprising sponges that were not used during the procedure. In addition, the handheld computer may be configured to process data of the discarded surgical sponges, unused surgical sponges, and available surgical sponges to determine if any available surgical sponge is not discarded and is not unused.

Thus, in one embodiment a system for tracking surgical sponges for a medical procedure in which used sponges are discarded. The system may comprise a sleeve having a first open end and a second open end; a base; a receptacle having an open end, a closed end, one or more longitudinal inner surfaces, and one or more longitudinal outer surfaces; said one or more longitudinal inner surface and said closed end defining, at least in part, an inside area of said receptacle; said sleeve being configured to be disposed outside the one or more longitudinal outer surfaces of said receptacle; said sleeve being configured to be removably attached to said base; said sleeve including an RF reader having a first antenna assembly comprised of at least one antenna; said RF reader configured to receive identifying (ID) information from radiated discarded sponges that enter the inside area of said receptacle; and a first wireless transmitter electrically connected to said RF reader and configured to receive from said RF reader the ID information of discarded sponges that enter the inside area of said receptacle and to wirelessly transmit the ID information of discarded sponges. The system may also include a portable computing device having a wireless port and configured to wirelessly receive the ID information wirelessly transmitted by said first wireless transmitter.

Further, the portable computing device may be configured to store in memory ID information of a plurality of available surgical sponges comprising sponges available for use for the procedure; to receive and store ID information of a plurality of unused surgical sponges comprising sponges available for use for the procedure and that were not used during the procedure; and responsive to an input to process data of the discarded surgical sponges, unused surgical sponges, and available surgical sponges to determine if any available surgical sponge is not discarded and is not unused. The system may further include a tray having an RF reader configured to radiate one or more sponges on said tray; and said RF reader of said tray may be configured to communicate with said portable computing device to provide ID information of each sponge radiated said RF reader of said tray. The portable computing device may be configured to receive bar code data associated with each of the plurality of available surgical sponges; receive and store ID information of a multitude of surgical sponges available for use for the procedure; and compare a quantity of bar code bar code data associated with each of the plurality of available surgical sponges with a quantity of ID information of the multitude of surgical sponges and, if there is a disparity, to output a notification.

The sleeve may include a second wireless transmitter electrically connected to said RF reader and, if enabled, configured to receive from said RF reader the ID information of radiated sponges and to wirelessly transmit the ID information of radiated sponges. In this embodiment the first wireless transmitter may comprise a Bluetooth transceiver and the second wireless transceiver may comprise a Wifi transceiver.

In another embodiment, the system comprises a sleeve having a first open end and a second open end; the sleeve being configured to be removably disposed outside an outer surface of the receptacle; said sleeve including an RF reader having a first antenna assembly comprised of at least one antenna; said RF reader configured to radiate sponges that enter the receptacle and to receive identifying (ID) information from radiated sponges; and a first wireless transmitter electrically connected to said RF reader and configured to receive from said RF reader the ID information of radiated sponges and to wirelessly transmit the ID information of radiated sponges. The system may include a portable computing device having a wireless port and configured to wirelessly receive the ID information of radiated sponges from said wireless transmitter. The portable computing device may be configured to store in memory ID information of a plurality of available surgical sponges comprising sponges available for use for the procedure; to receive and store ID information of a plurality of unused surgical sponges comprising sponges available for use for the procedure and that were not used during the procedure; and be responsive to an input to process data of the discarded surgical sponges, unused surgical sponges, and available surgical sponges to determine if any available surgical sponge is not discarded and is not unused. The system may further comprise a second wireless transmitter electrically connected to said RF reader and, if enabled, configured to receive from said RF reader the ID information of radiated sponges and to wirelessly transmit the ID information of radiated sponges.

In still another embodiment, the may comprise a sleeve having a first open end and a second open end; a base having a plurality of castors to permit movement of said base over a traveling surface; said sleeve being configured to be removably attached to said base; said sleeve being configured to be removably disposed outside an outer surface of the receptacle; said sleeve including an RF reader having a first antenna assembly comprised of at least one antenna; said RF reader configured to radiate sponges that enter the receptacle; said RF reader configured to receive identifying (ID) information from radiated sponges; and a first wireless transmitter electrically connected to said RF reader configured to receive from said RF reader the ID information of radiated sponges and to wirelessly transmit the ID information of radiated sponges. The system may include a portable computing device having a wireless port and configured to wirelessly receive the ID information of radiated sponges from said wireless transmitter. The system may further comprise a tray having an RF reader configured to radiate one or more sponges on said tray; said RF reader of said tray being configured to communicate with said portable computing device to provide ID information of each sponge radiated by said RF reader of said tray. The system may further comprise a second sleeve with the same features of the first sleeve and wherein said portable computing device is configured to wirelessly communicate concurrently (although not necessarily simultaneously) with the first wireless transmitter and the second wireless transmitter to receive ID information. The system may further comprise a scale assembly configured to measure s weight of the receptacle; said scale assembly configured to be removable disposed under the receptacle; and said scale assembly comprising a second wireless transceiver configured to wirelessly transmit weight data.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

What is claimed is:

1. A system for tracking surgical sponges for a medical procedure in which used sponges are discarded, comprising:
a sleeve having a first open end and a second open end;
a base;
a receptacle having an open end, a closed end, one or more longitudinal inner surfaces, and one or more longitudinal outer surfaces;
said one or more longitudinal inner surface and said closed end defining, at least in part, an inside area of said receptacle;
said sleeve being configured to be disposed outside the one or more longitudinal outer surfaces of said receptacle;
said sleeve being configured to be removably attached to said base;
said sleeve including an RF reader having a first antenna assembly comprised of at least one antenna;
said RF reader configured to receive identifying (ID) information from radiated discarded sponges that enter the inside area of said receptacle; and
a first wireless transmitter electrically connected to said RF reader and configured to receive from said RF reader the ID information of discarded sponges that enter the inside area of said receptacle and to wirelessly transmit the ID information of discarded sponges.

2. The system of claim 1, further comprising a portable computing device having a wireless port and configured to wirelessly receive the ID information wirelessly transmitted by said first wireless transmitter.

3. The system of claim 2, wherein said portable computing device is configured to store in memory ID information of a plurality of available surgical sponges comprising sponges available for use for the procedure;
wherein said portable computing device is configured to receive and store ID information of a plurality of unused surgical sponges comprising sponges available for use for the procedure and that were not used during the procedure; and
wherein said portable computing device is responsive to an input to process data of the discarded surgical sponges, unused surgical sponges, and available surgical sponges to determine if any available surgical sponge is not discarded and is not unused.

4. The system of claim 3, further comprising a tray having an RF reader configured to radiate one or more sponges on said tray; and
said RF reader of said tray being configured to communicate with said portable computing device to provide ID information of each sponge radiated said RF reader of said tray.

5. The system of claim 4, wherein said portable computing device is configured to receive bar code data associated with each of the plurality of available surgical sponges;
wherein said portable computing device is configured to receive and store ID information of a multitude of surgical sponges available for use for the procedure; and
wherein said computing device is configured to compare a quantity of bar code bar code data associated with each of the plurality of available surgical sponges with a quantity of ID information of the multitude of surgical sponges and, if there is a disparity, to output a notification.

6. The system of claim 2, further comprising a tray having an RF reader configured to radiate one or more sponges on said tray; and
said RF reader of said tray being configured to communicate with said portable computing device to provide ID information of each sponge radiated said RF reader of said tray.

7. The system of claim 2, wherein said portable computing device is configured to receive bar code data associated with each of the plurality of available surgical sponges;
wherein said portable computing device is configured to receive and store ID information of a multitude of surgical sponges available for use for the procedure; and
wherein said computing device is configured to compare a quantity of bar code bar code data associated with each of the plurality of available surgical sponges with a quantity of ID information of the multitude of surgical sponges and, if there is a disparity, to output a notification.

8. The system of claim 1, wherein said sleeve includes a second wireless transmitter electrically connected to said RF reader and, if enabled, configured to receive from said RF reader the ID information of radiated sponges and to wirelessly transmit the ID information of radiated sponges.

9. The system of claim 8, wherein said first wireless transmitter comprises a Bluetooth transceiver and said second wireless transceiver comprises a Wifi transceiver.

10. A system for tracking surgical sponges for a medical procedure in which used sponges are discarded into a receptacle, comprising:
a sleeve having a first open end and a second open end;
said sleeve being configured to be removably disposed outside an outer surface of the receptacle;
said sleeve including an RF reader having a first antenna assembly comprised of at least one antenna;
said RF reader configured to radiate sponges that enter the receptacle and to receive identifying (ID) information from radiated sponges; and
a first wireless transmitter electrically connected to said RF reader and configured to receive from said RF reader the ID information of radiated sponges and to wirelessly transmit the ID information of radiated sponges.

11. The system of claim 10, further comprising a portable computing device having a wireless port and configured to wirelessly receive the ID information of radiated sponges from said wireless transmitter.

12. The system of claim 11, wherein said portable computing device is configured to store in memory ID information of a plurality of available surgical sponges comprising sponges available for use for the procedure;
wherein said portable computing device is configured to receive and store ID information of a plurality of unused surgical sponges comprising sponges available for use for the procedure and that were not used during the procedure; and
wherein said portable computing device is responsive to an input to process data of the discarded surgical sponges, unused surgical sponges, and available surgical sponges to determine if any available surgical sponge is not discarded and is not unused.

13. The system of claim 10, wherein said wireless transmitter comprises a Bluetooth transceiver.

14. The system of claim 10, further comprising a second wireless transmitter electrically connected to said RF reader and, if enabled, configured to receive from said RF reader the ID information of radiated sponges and to wirelessly transmit the ID information of radiated sponges.

15. The system of claim 14, wherein said first wireless transmitter comprises a Bluetooth transceiver and second wireless transceiver comprises a Wifi transceiver.

16. The system of claim 10, further comprising a tray having an integrated RF reader configured to radiate one or more sponges on said tray; and
said RF reader of said tray being configured to communicate with a portable computing device to provide ID information of each sponge radiated said RF reader of said tray.

17. The system of claim 10, further comprising a portable computing device having a wireless port and configured to wirelessly receive the ID information of radiated sponges from said wireless transmitter;
wherein said portable computing device is configured to receive bar code data associated with each of the plurality of available surgical sponges;
wherein said portable computing device is configured to receive and store ID information of a multitude of surgical sponges available for use for the procedure and wherein said ID information of a multitude of surgical sponges available for use originates from an RF reader; and
wherein said computing device is configured to compare a quantity of bar codes with a quantity of ID information of the multitude of surgical sponges and, if there is a disparity, to output a notification.

18. A system for tracking surgical sponges for a medical procedure in which used sponges are discarded into a receptacle, comprising:
a sleeve having a first open end and a second open end;
a base having a plurality of castors to permit movement of said base over a traveling surface;
said sleeve being configured to be removably attached to said base;
said sleeve being configured to be removably disposed outside an outer surface of the receptacle;
said sleeve including an RF reader having a first antenna assembly comprised of at least one antenna;
said RF reader configured to radiate sponges that enter the receptacle;
said RF reader configured to receive identifying (ID) information from radiated sponges; and
a first wireless transmitter electrically connected to said RF reader configured to receive from said RF reader the ID information of radiated sponges and to wirelessly transmit the ID information of radiated sponges.

19. The system of claim 18, further comprising a portable computing device having a wireless port and configured to wirelessly receive the ID information wirelessly transmitted by said first wireless transmitter.

20. The system of claim 19, further comprising a tray having an RF reader configured to radiate one or more sponges on said tray; and
said RF reader of said tray being configured to communicate with said portable computing device to provide ID information of each sponge radiated by said RF reader of said tray.

21. The system of claim 19, further comprising:
a second sleeve having a first open end and a second open end;
said second sleeve being configured to be removably disposed outside an outer surface of a second receptacle;
said second sleeve including a second RF reader having a second antenna assembly comprised of at least one antenna;
said second RF reader configured to radiate sponges that enter the second receptacle;
said second RF reader configured to receive identifying (ID) information from radiated sponges that enter the second receptacle;
said second sleeve comprising a second wireless transmitter electrically connected to said second RF reader and configured to:
receive from said second RF reader the ID information of radiated sponges therefrom; and
wirelessly transmit the ID information of radiated sponges that enter the second receptacle to the portable computing device; and
wherein said portable computing device is configured to wirelessly communicate concurrently with the first wireless transmitter and the second wireless transmitter to receive ID information.

22. The system of claim 18, wherein said sleeve includes a second wireless transmitter electrically connected to said RF reader and, if enabled, configured to receive from said RF reader the ID information of radiated sponges and to wirelessly transmit the ID information of radiated sponges.

23. The system of claim 18, further comprising:
a scale assembly configured to measure s weight of the receptacle;
said scale assembly configured to be removable disposed under the receptacle; and
said scale assembly comprising a second wireless transceiver configured to wirelessly transmit weight data.
